(19) United States
(12) Patent Application Publication
(10) Pub. No.: US 2026/0039193 A1
(43) Pub. Date: Feb. 5, 2026

(54) RECONFIGURABLE SWITCHED-CAPACITOR CONVERTER WITH INPUT INDUCTOR

(71) Applicant: Cirrus Logic International Semiconductor Ltd., Edinburgh (GB)

(72) Inventor: Fred CHEN, Oakland, CA (US)

(73) Assignee: Cirrus Logic International Semiconductor Ltd., Edinburgh (GB)

(21) Appl. No.: 19/252,557

(22) Filed: Jun. 27, 2025

Related U.S. Application Data
(60) Provisional application No. 63/676,975, filed on Jul. 30, 2024.

(51) Int. Cl. H02M 3/07

(52) U.S. Cl. CPC H02M 3/07

(57) ABSTRACT

A system may include an input inductor configured to receive an input voltage and a reconfigurable power converter coupled to the input inductor at an intermediate inductor node and configured to dynamically adjust an intermediate inductor node voltage on the intermediate inductor node by reconfiguring a topology of the reconfigurable power converter.

### RELATED APPLICATION

The present disclosure claims priority to U.S. Provisional Patent Application No. 63/676,975, filed Jul. 30, 2024, which in incorporated by reference herein in its entirety.

### FIELD OF DISCLOSURE

The present disclosure relates in general to circuits for electronic devices, including without limitation personal audio devices such as wireless telephones and media players, and more specifically, a reconfigurable switched-capacitor power converter with an input inductor.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter).

Power converters may also be implemented in various ways. For example, a power converter may comprise an inductor-based power converter comprising a power inductor and various switches coupled to and arranged relative to the power inductor in order to perform the desired function of such power converter. As another example, a power converter may comprise a switched-capacitor power converter comprising one or more capacitors and various switches coupled to and arranged relative to the one or more capacitors in order to perform the desired function of such power converter. In some instances, a switched-capacitor power converter may be reconfigurable, in which it may be reconfigured among many different converter ratios, e.g. 3:1, 2:1, and 1:1.

Many systems may include multiple regulation/power converter stages. One general trend in mobile systems is having an efficient voltage step-down (i.e., buck) stage shared by multiple regulation stages. Such approach may allow for smaller magnetics and a more efficient regulation stage. A switched-capacitor power converter may be a candidate for such a step-down stage, due to its relative efficiency compared to other power converter architectures. However, the unregulated output of a switched-capacitor power converter may cause brownout conditions for devices downstream of the switched-capacitor power converter. For example, an output voltage of the switched-capacitor power converter may become too low during high load transients at its output, due to many factors including without limitation a voltage drop across a power distribution network (e.g., with a battery cell or battery pack coupled to an input of the power converter), such as electrical resistances present in the power distribution network. Switched-capacitor converters are not able to compensate for voltage drops due to external impedances, which thus limit a useful range of a battery coupled to a switched-capacitor power converter,

### SUMMARY

In accordance with the teachings of the present disclosure, one or more disadvantages and problems associated with the use of switched-capacitor power converters may be reduced or eliminated.

In accordance with embodiments of the present disclosure, a system may include an input inductor configured to receive an input voltage and a reconfigurable power converter coupled to the input inductor at an intermediate inductor node and configured to dynamically adjust an intermediate inductor node voltage on the intermediate inductor node by reconfiguring a topology of the reconfigurable power converter.

In accordance with these and other embodiments of the present disclosure, a method may include, in a system having an input inductor configured to receive an input voltage, dynamically adjusting, by a reconfigurable power converter coupled to the input inductor at an intermediate inductor node, an intermediate inductor node voltage on the intermediate inductor node by reconfiguring a topology of the reconfigurable power converter.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example power delivery network, in accordance with embodiments of the present disclosure;

FIG. 2 illustrates a circuit diagram of selected components of an example switch-capacitor power converter fragment, in accordance with embodiments of the present disclosure;

FIG. 3 illustrates example waveforms for an input inductor current and intermediate inductor node voltage during operation of the example power delivery network of FIG. 1, in accordance with embodiments of the present disclosure;

FIGS. 4A and 4B (which may be referred to herein collectively as “FIG. 4”) illustrate an example switching sequence for duty cycling between 3:1 and 2:1 conversion ratios of the switched-capacitor power converter shown in FIG. 1, in accordance with embodiments of the present disclosure;

FIGS. 5A and 5B (which may be referred to herein collectively as “FIG. 5”) illustrate an example switching sequence for duty cycling between 2:1 and 1:1 conversion ratios of the switched-capacitor power converter shown in FIG. 1, in accordance with embodiments of the present disclosure;

FIG. 6 illustrates a graph of example input and output voltage levels versus conversion ratio mode for the switched-capacitor power converter shown in FIG. 1, in accordance with embodiments of the present disclosure;

FIG. 7 illustrates a block diagram of an example control circuit for controlling a power converter, in accordance with embodiments of the present disclosure; and

FIG. 8 illustrates example waveforms for an input inductor current and intermediate inductor node voltage during operation of the example power delivery network of FIG. 1, in accordance with embodiments of the present disclosure.

### DETAILED DESCRIPTION

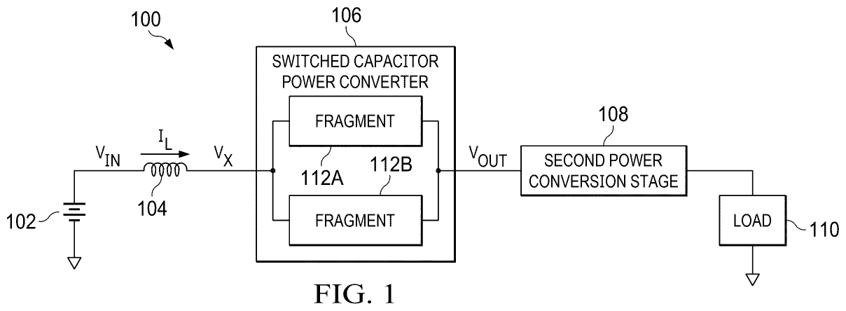

FIG. 1 illustrates a block diagram of selected components of an example power delivery network 100, in accordance with embodiments of the present disclosure. As shown in FIG. 1, power delivery network 100 may include a battery 102, an input inductor 104, a switched-capacitor power converter 106, a second power conversion stage 108, and a load 110.

Battery 102 may include any system, device, or apparatus configured to convert chemical energy stored within battery 102 to electrical energy, in order to generate an input voltage VIN to the remainder of power delivery network 100. For example, in some embodiments, battery 102 may be integral to a portable electronic device, and battery 102 may be configured to deliver electrical energy to components of such portable electronic device. Further, battery 102 may also be configured to recharge, in which it may convert electrical energy received by battery 102 into chemical energy to be stored for later conversion back into electrical energy. As an example, in some embodiments, battery 102 may comprise a lithium-ion battery.

Input inductor 104 may be coupled between battery 102 (or another power source) and an input (e.g., at an electrical node having an intermediate inductor node voltage V_{X}) of switched-capacitor power converter 106 and may include any suitable passive two-terminal electrical component that stores energy in a magnetic field when an electric current flows through it, such that when an inductor current I_{L} flowing through input inductor 104 changes, a time-varying magnetic field of input inductor 104 induces an electromotive force in input inductor 104, as described by Faraday's law of induction.

Switched-capacitor power converter 106 may include any system, device, or apparatus configured to convert a source of direct current (DC) from one voltage level (e.g., the intermediate inductor node voltage V_{X}) at its input to another voltage level for an output voltage V_{OUT} at an output of switched-capacitor power converter 106. In some embodiments, switched-capacitor power converter 106 may comprise a step-down or buck converter, wherein V_{OUT}≤V_{IN}. As its name implies, switched-capacitor power converter 106 may include one or more capacitors and various switches coupled to and arranged relative to the one or more capacitors in order to perform power conversion, as described in greater detail below. Further, switched-capacitor power converter 106 may be a reconfigurable power converter, wherein the various switches of switched-capacitor power converter 106 may be controlled and commutated to modify a conversion ratio (i.e., the ratio of inductor node voltage V_{X} to output voltage V_{OUT}) of switched-capacitor power converter 106 as needed. For example, in some embodiments, switched-capacitor power converter 106 may be reconfigured among conversion ratios of 3:1, 2:1, and 1:1. In addition, switched-capacitor power converter 106 may be configured to, as described in greater detail below, modulate intermediate inductor node voltage V_{X}.

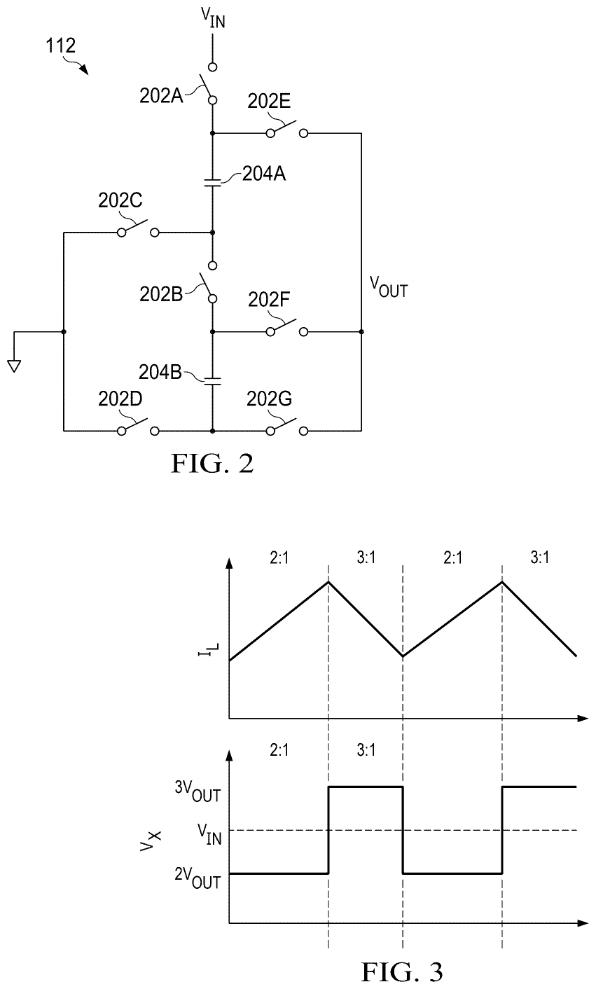

As shown in FIG. 1, switched-capacitor power converter 106 may include a plurality of fragments 112 (e.g., fragments 112A and 112B), each fragment 112 having an input co-terminus with the input of switched-capacitor power converter 106 and having an output co-terminus with the output of switched-capacitor power converter 106. A fragment 112 may also be referred to as a “phase” of switched-capacitor power converter 106. An example implementation of a fragment 112 is set forth in FIG. 2 and described in greater detail below. For purposes of clarity and exposition, switched-capacitor power converter 106 is shown in FIG. 1 as comprising two fragments 112. However, in some embodiments, switched-capacitor power converter 106 may include three or more fragments 112.

Second power conversion stage 108 may include any system, device, or apparatus configured to convert a source of direct current (DC) from one voltage level (e.g., output voltage V_{OUT}) at its input to another voltage level at an output of second power conversion stage 108. Second power conversion stage 108 may comprise one or more power converters, including one or more inductive-based power converters and/or one or more switched-capacitor power converters, and including one or more boost converters, buck converters, and/or buck-boost converters. In these and other embodiments, second power conversion stage 108 may include a power management integrated circuit (PMIC).

Load 110 may include any appropriate electrical or electronic load that may be powered from battery 102 and other components of power distribution network 100, including without limitation a processor or other integrated circuit.

FIG. 2 illustrates a circuit diagram of selected components of an example switch-capacitor power converter fragment 112, which may be used to implements either or both of fragments 112A and 112B shown in FIG. 1, in accordance with embodiments of the present disclosure. Switch-capacitor power converter fragment 112 may comprise a plurality (e.g., seven) of switches 202A-202G and a plurality (e.g., two) of capacitors 204A and 204B coupled to one another and arranged as shown in FIG. 2. While FIG. 2 shows an example architecture for switch-capacitor power converter fragment 112, other suitable architectures may be used.

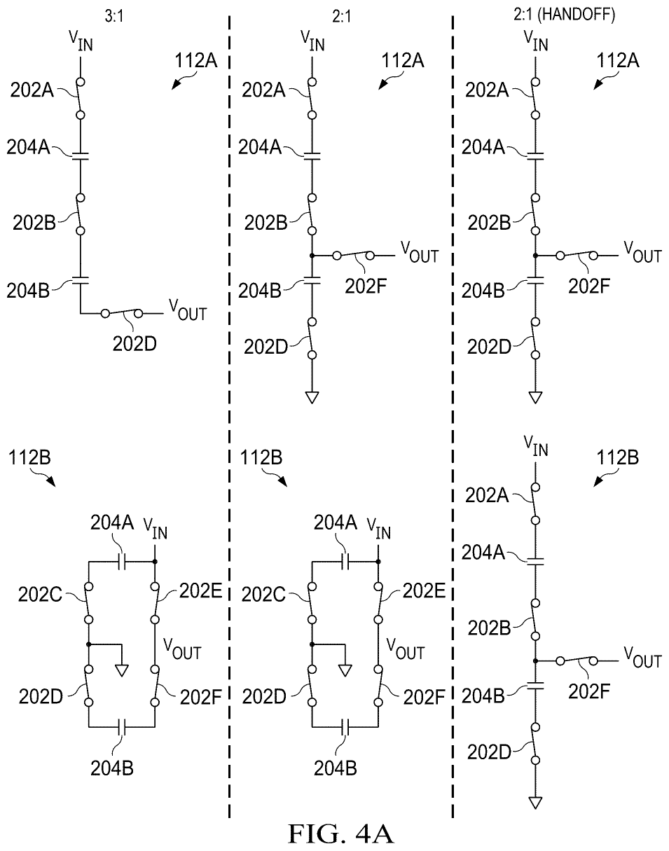

FIG. 3 illustrates example waveforms for inductor current I_{L}, and intermediate inductor node voltage V_{X} during operation of power delivery network 100, in accordance with embodiments of the present disclosure. As shown in FIG. 3, switch-capacitor power converter 106 may be controlled to duty cycle between different conversion ratios (e.g., between 3:1 and 2:1 as shown in FIG. 3) to enable regulation of output voltage V_{OUT} and live reconfiguration of switch-capacitor power converter 106. By doing so, switch-capacitor power converter 106 may modulate intermediate inductor node voltage V_{X} between multiples of output voltage V_{OTU} (e.g., between 2V_{OUT} and 3V_{OUT} as shown in FIG. 3). Under such approach, switch-capacitor power converter 106 may regulate output voltage V_{OUT} within the range of conversion ratios of switch-capacitor power converter 106, while minimizing losses via input inductor 104 (e.g., low DC inductor current I_{L}, and low ripple of inductor current I_{L}). Such approach also allows for live (i.e., loaded) transitions between different conversion ratios while maintaining efficiency close to that of a “pure” switch-capacitor power converter 106 (e.g., a power delivery network 100 without input inductor 104).

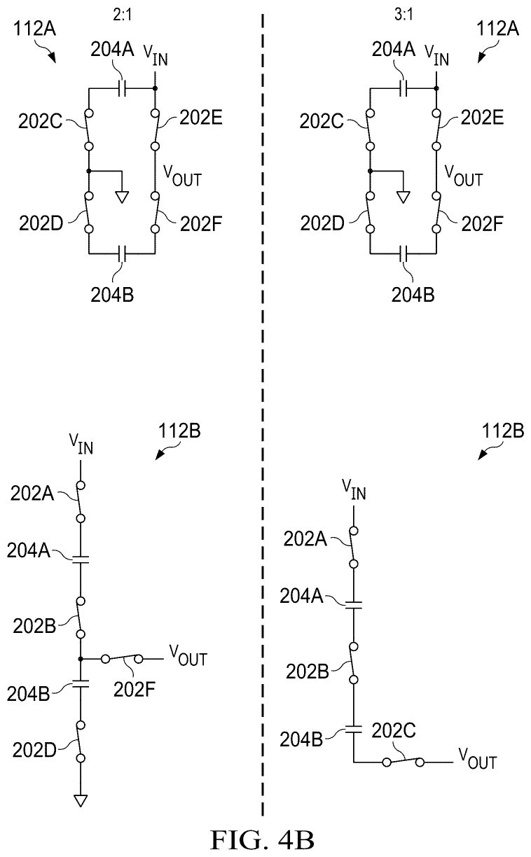

The functionality of the approach shown in FIG. 3 may be realized by operating switches of switch-capacitor power converter 106 to execute a particular switching sequence. For example, FIG. 4 illustrates an example switching sequence for duty cycling between 3:1 and 2:1 conversion ratios of switched-capacitor power converter 106, in accordance with embodiments of the present disclosure. For the example switching sequence shown in FIG. 4, a series/parallel switching topology may be used for fragments 112A and 112B. Such topology may allow for changes in converter ratios within the same phase, maintenance of a low impedance on the intermediate inductor node (i.e., electrical node of intermediate inductor node voltage V_{X}), and balancing of capacitors 204A and 204B of fragments 112A and 112B. In this topology, output voltage V_{OUT} may be determined by a duration of each conversion ratio relative to the other in a switching sequence. For example, in the switching sequence of FIG. 4, a 100% duty cycle may imply an integer conversion of 3:1, a 0% duty cycle may imply an integer conversion of 2:1, and a 50% duty cycle may imply a conversion of 2.5:1. For a given duty cycle and value of input voltage V_{IN}, a natural ripple of the voltage across input inductor 104 and V_{OUT} ratio may result, thus allowing for feedforward control of switched-capacitor power converter 106 to regulate intermediate inductor node voltage V_{X} by modifying the conversion ratio of switched-capacitor power converter 106 while maintaining output voltage V_{OUT} substantially constant. “Feedforward control” in this context means providing control without feedback of output voltage V_{OUT}, which may provide for a faster transient response as compared to feedback-based control. Under such feedforward control mechanism, output voltage V_{OUT} may be set by adjusting the duty cycle of switches 202A-202G in switched-capacitor power converter 106. Such control approach may allow switched-capacitor power converter 106 to quickly converge to the appropriate currents and voltages, thereby providing a fast transient response to changes in load or input conditions.

Stated another way, the control mechanism for switched-capacitor power converter 106 need only know an input (e.g., input voltage V_{IN}) and desired output voltage V_{OUT}, and from that determine the switching of switches 202A-202G of fragments 112A and 112B required to maintain the desired output voltage V_{OUT}. As a result, intermediate inductor node voltage V_{X} may not be switched between independent rails. Instead, intermediate inductor node voltage V_{X} may always be coupled to a voltage rail that may change according to the configuration of switched-capacitor power converter 106. Accordingly, intermediate inductor node voltage V_{X} may follow the optimal voltage required for efficient operation, thus improving overall efficiency and minimizing losses.

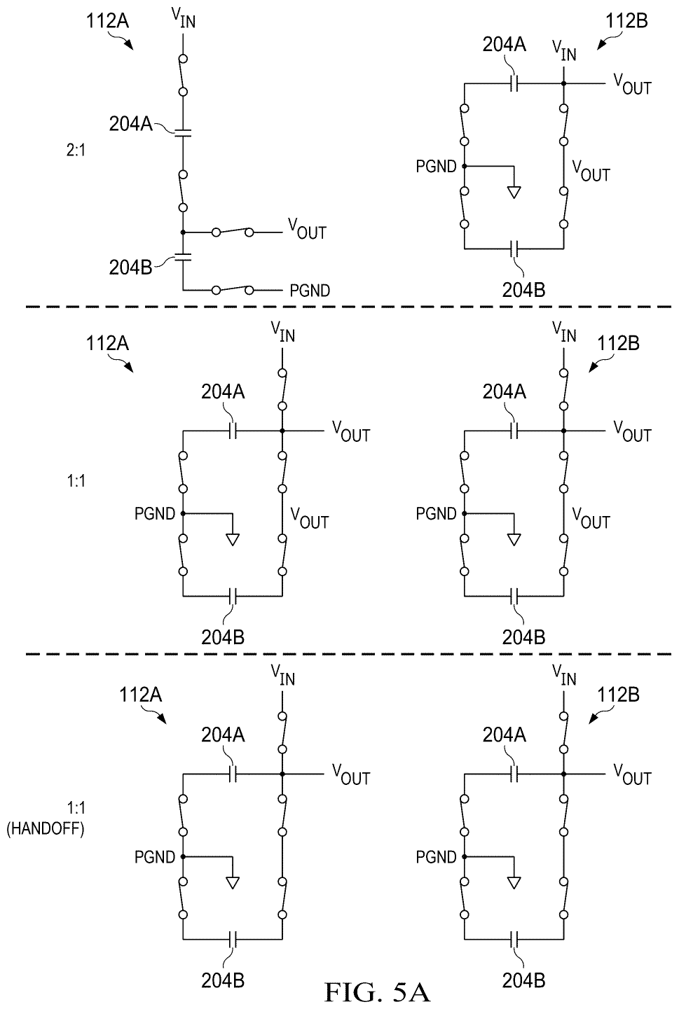

As another example, FIG. 5 illustrates an example switching sequence for duty cycling between 2:1 and 1:1 conversion ratios of switched-capacitor power converter 106, in accordance with embodiments of the present disclosure. Similar to that shown in FIG. 4, in FIG. 5, output voltage V_{OUT} may be determined by a duration of each conversion ratio relative to the other in a switching sequence, wherein a 100% duty cycle may imply an integer conversion of 2:1, a 0% duty cycle may imply an integer conversion of 1:1, and a 50% duty cycle may imply a conversion of 1.5:1.

Accordingly, switched-capacitor power converter 106 may reconfigure itself into different topologies without the need for additional switches, allowing the intermediate inductor node voltage to couple to different voltage rails. Such reconfiguration may modify an effective conversion ratio and allow switched-capacitor power converter 106 to adapt to different load conditions.

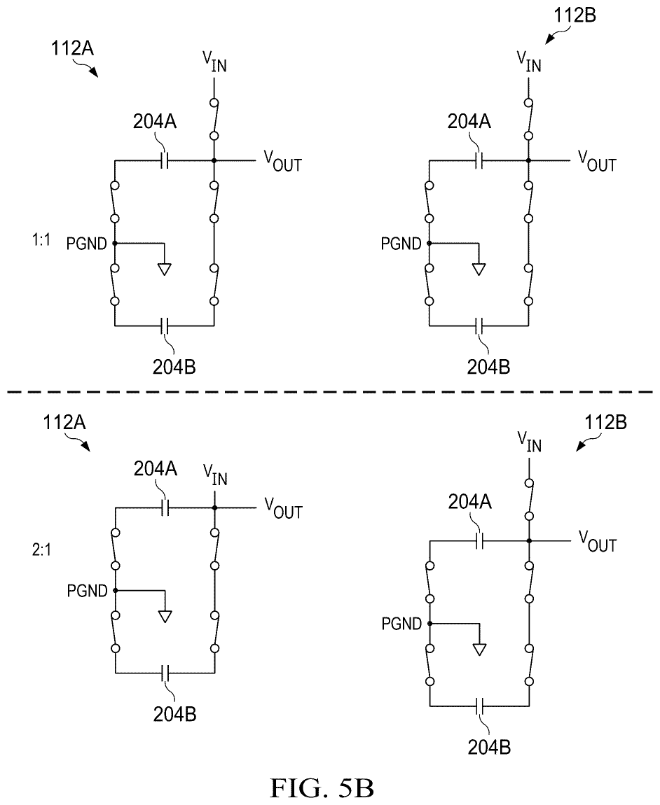

FIG. 6 illustrates a graph of example values of input voltage V_{IN} and output voltage V_{OUT} versus conversion ratio mode for switched-capacitor power converter 106. In particular, FIG. 6 may demonstrate a possible application for the approach shown and described above, such application being operating switched-capacitor power converter 106 to ensure a minimum value for output voltage V_{OUT}. In such an application, switched-capacitor power converter 106 may operate mainly in integer conversion ratios, thus limiting ripple on input inductor 104 and maximizing efficiency as it allows for phase shedding and frequency scaling without a need to manage inductor current ripple. In the example of FIG. 6, the minimum value for output voltage V_{OUT} is 3.5V. In some embodiments, the application shown in FIG. 6 may create margin against load steps while maximizing efficiency.

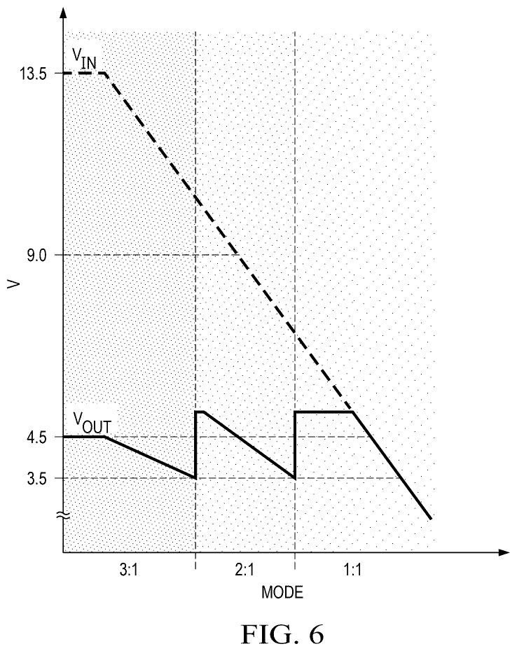

While many different possible control schemes may be used for controlling switched-capacitor power converter 106, FIG. 7 illustrates a block diagram of an example control circuit 700 for controlling a power converter, in accordance with embodiments of the present disclosure. For example, as shown in FIG. 7, control circuit 700 may include a duty cycle generator 702, a feedback summer 704, a clock generation circuit 706, and a duty correction circuit 708.

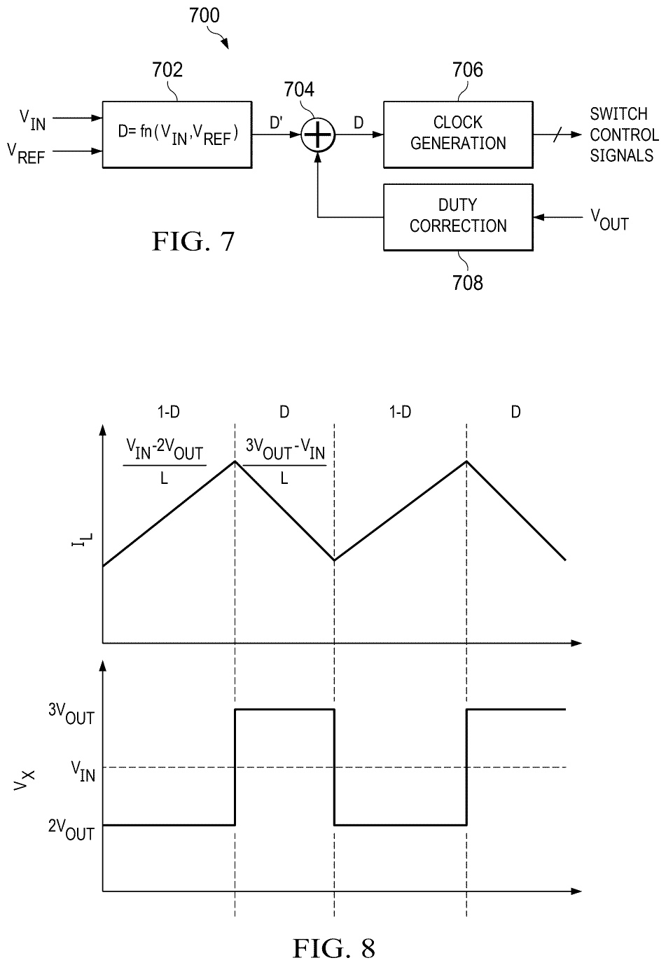

Duty cycle generator 702 may comprise any suitable system, device, or apparatus configured to generate a raw duty cycle signal D′, as a function of input voltage V_{IN} and a reference voltage V_{REF}, representing a ratio of time between which switched-capacitor power converter 106 may operate between different conversion ratios. For example, FIG. 8 illustrates example waveforms for an input inductor current and intermediate inductor node voltage during operation of power delivery network 100 operating between conversion ratios of 2:1 and 3:1, in accordance with embodiments of the present disclosure. When operating between such conversion ratios, switched-capacitor power converter 106 may operate at the 3:1 ratio for a ratio of time D and operate at the 2:1 for a ratio of time (1-D). A given duty cycle D may produce a deterministic ratio of V_{IN} to V_{OUT}, thus enabling feedforward control. Many different implementations of duty cycle generator 702 are possible and are beyond the scope of this disclosure.

Feedback summer 704 may comprise any suitable system, device, or apparatus configured to combine raw duty cycle signal D′ and a correction signal generated by duty correction circuit 708 in order to generate duty cycle signal D. Duty correction circuit 708 may comprise any suitable system, device, or apparatus configured to correct for errors in the feedforward path by generating the correction signal as a function of output voltage V_{OUT}.

Clock generation circuit 706 may comprise any suitable system, device, or apparatus configured to, based on duty cycle signal D, generate appropriate switching signals for switches 202A-G to operate with the desired duty cycle and conversion ratio.

In some embodiments, input inductor 104 may have a bypass switch in parallel therewith, in which such bypass switch may be controlled by switched-capacitor power converter 106 or the controller for switched-capacitor power converter 106. In such embodiments, switched-capacitor power converter 106 may effectively operate in two different modes: (a) a first mode in which input inductor 104 is provided at the input of switched-capacitor power converter 106; and (b) a second mode in which input inductor 104 is bypassed, such that switched-capacitor power converter 106 operates as a “pure” switched capacitor converter. Notably, such bypass switch is not needed in order to operate as a “pure” switched-capacitor converter, but rather such bypass switch may merely serve to lower a direct-current resistance of inductor 104.

While switched-capacitor power converter 106 is described above as having input inductor 104 arranged at an input of switched-capacitor power converter 106 to provide a buck or step-down function, it is understood that switched-capacitor power converter 106 may also be operated as a boost or step-up power converter. In such an implementation, such power converter may be operated in a reverse direction to that as described above (e.g., input inductor 104 may be arranged at the output of such power converter). In effect, input inductor 104 may be coupled to the higher-voltage terminal of a switched-capacitor power converter.

Further, although the foregoing contemplates use of a switched-capacitor power converter 106, any suitable power converter may be used.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
an input inductor configured to receive an input voltage; and
a reconfigurable power converter coupled to the input inductor at an intermediate inductor node and configured to dynamically adjust an intermediate inductor node voltage on the intermediate inductor node by reconfiguring a topology of the reconfigurable power converter.

2. The system of claim 1, wherein the reconfigurable power converter comprises a feedforward control subsystem that controls an output voltage at an output of the reconfigurable power converter by controlling a duty cycle of switches of the reconfigurable power converter.

3. The system of claim 1, wherein the reconfigurable power converter is further configured to achieve different non-integer voltage conversion ratios by modifying its topology.

4. The system of claim 1, wherein the reconfigurable power converter is further configured to dynamically modify its topology based on a desired output voltage of the reconfigurable power converter and load conditions at an output of the reconfigurable power converter.

5. The system of claim 1, wherein the reconfigurable power converter is further configured to maintain a direct-current current profile of the input inductor by continuously coupling the intermediate inductor node to a voltage rail with a level that is modified based on the switch topology.

6. The system of claim 1, wherein the reconfigurable power converter is further configured to balance capacitors of the reconfigurable power converter via a switching sequence that reconfigured the switch topology.

7. The system of claim 1, further comprising a switch coupled in parallel with the input inductor and configured to:
operate in a first mode in which the switch is enabled to bypass the input inductor; and
operate in a second mode in which the switch is disabled.

8. The system of claim 1, wherein the reconfigurable power converter comprises a reconfigurable switched-capacitor power converter.

9. A method comprising, in a system having an input inductor configured to receive an input voltage:
dynamically adjusting, by a reconfigurable power converter coupled to the input inductor at an intermediate inductor node, an intermediate inductor node voltage on the intermediate inductor node by reconfiguring a topology of the reconfigurable power converter.

10. The method of claim 9, further comprising controlling, by a feedforward control subsystem of the reconfigurable power converter, an output voltage at an output of the reconfigurable power converter by controlling a duty cycle of switches of the reconfigurable power converter.

11. The method of claim 9, further comprising modifying a topology of the reconfigurable power converter to achieve different non-integer voltage conversion ratios.

12. The method of claim 9, further comprising dynamically modify a topology of the reconfigurable power converter based on a desired output voltage of the reconfigurable power converter and load conditions at an output of the reconfigurable power converter.

13. The method of claim 9, further comprising maintaining, by the reconfigurable power converter, a direct-current current profile of the input inductor by continuously coupling the intermediate inductor node to a voltage rail with a level that is modified based on the switch topology.

14. The method of claim 9, further comprising balancing, by the reconfigurable power converter, capacitors of the reconfigurable power converter via a switching sequence that reconfigured the switch topology.

15. The method of claim 9, the system further comprising a switch coupled in parallel with the input inductor and the method further comprising:
operating the switch in a first mode in which the switch is enabled to bypass the input inductor; and
operating the switch in a second mode in which the switch is disabled.

16. The method of claim 9, wherein the reconfigurable power converter comprises a reconfigurable switched-capacitor power converter.
